(19) United States
(12) Patent Application Publication
(10) Pub. No.: US 2007/0180861 A1
(43) Pub. Date: Aug. 9, 2007

(54) Optical glass element molding method

(75) Inventors: Shunichi Hayamizu, Amagasaki-shi (JP); Tadafumi Sakata, Kobe-shi (JP); Tadashi Sugiyama, Tokyo (JP)

Correspondence Address: BRINKS HOFER GILSON & LIONE, P.O. BOX 10395, CHICAGO, IL, 60610, US

(73) Assignee: KONICA MINOLTA OPTO, INC., Hachioji-shi (JP)

(21) Appl. No.: 11/656,160

(22) Filed: Jan. 22, 2007

(30) Foreign Application Priority Data
Jan. 25, 2006 (JP) 2006-016448

(51) Int. Cl. C03B 23/00; C03B 29/00

(52) U.S. Cl. 65/102

(57) ABSTRACT

A preform is supplied between a pair of molding dies, followed by heating, softening and pressing. A smallest radius of curvature in the preform is smaller than a radius of a globular member having a volume equal to that of the preform. In this fabricating method, -an abutment portion between the molding die and the preform is located at a curved surface or the center of the molding die, thereby preventing any local abutment of the preform against the molding die.

The present application claims priority to Japanese Patent Application No. 2006-16448 filed Jan. 25, 2006, the entire content of which is hereby incorporated by reference.

### BACKGROUND OF THE INVENTION

1. Field of the Invention

The invention relates to a method for molding an optical glass element for use in an optical pickup apparatus and, more particularly, to a method for molding a fine optical glass element having a small radius of curvature and a great lens numerical aperture (NA).

2. Description of the Related Art

At present, an optical pickup apparatus (called “an optical head” or “an optical head device”) is used when information is recorded in or reproduced from an optical information recording medium (referred to as “an optical disk” or “a medium”) such as a CD (abbreviating “a compact disk”) or a DVD (abbreviating “a digital video disk” or “a digital versatile disk”).

There has been studied and developed the standard of a next-generation optical information recording medium using an optical information recording medium having a recording density higher than that of the current optical information recording medium. Examples of the standard of a next-generation optical information recording medium include an “HD DVD” standard and a “Blu-Ray Disc” standard.

Although a wavelength of a laser beam to be used is commonly 405 nm in both of the standards, structures of optical disks in the standards are different from each other, and therefore, characteristics of a lens for use in the optical pickup apparatus also are different from each other.

In other words, the “HD DVD” standard adopts a current DVD technique in many points, to be thus configured in a structure in which disks having a thickness of 0.6 mm are stuck to each other. The numerical aperture (NA) of an objective lens is 0.65, which is slightly greater than a numerical aperture of 0.60 for use in a current DVD.

In contrast, the “Blu-Ray Disc” standard has a structure in which a recording layer formed on a disk having a thickness of 1.1 mm is covered with a protective layer having a thickness of 0.1 mm. The numerical aperture (NA) of an objective lens is 0.85, which is much greater than the numerical aperture of 0.60 for use in the current DVD.

In this manner, the numerical aperture of the objective lens is required to be greater than that used in the current DVD in either of the standards in order to enhance resolution.

However, as the numerical aperture of the objective lens becomes greater, the optical surface of the objective lens largely projects in a convex shape with a smaller radius of curvature, as shown in FIG. 1 (see, for example, U.S. Pat. No. 6,191,889). It is really difficult to mass-produce a fine lens formed into such a shape shown in FIG. 1 by grinding. In view of this, there has been studied that a lens is inexpensively fabricated by pressing a substantially globular and fine glass material, i.e., a preform between a pair of molds.

The pressing of the substantially globular and fine glass material, that is, a molding preform having a radius R has raised problems as follows: if a radius R1 of curvature within an aperture height of the objective lens is smaller than the radius R of the substantially globular glass material, a substantially globular glass material 101 annularly linearly, that is, locally abuts against an edge 103 between a molding surface for molding an optically functional surface of the objective lens and a surface for molding a flange of the objective lens in a mold 102 in pressing, a molding pressure is concentratively applied to the abutment portion, as shown in FIG. 2. The high molding pressure is concentratively applied to the abutment portion at the edge 103, resulting in a problem of marked shortage of a lifetime of the mold 102.

### SUMMARY OF THE INVENTION

A principal object of the invention is to provide a method for molding an optical glass element, in which the lifetime of a molding die can be prolonged by preventing any local abutment of a preform against the molding die in pressing an optical glass element.

Furthermore, another object of the invention is to provide a method for readily fabricating a preform which cannot locally abut against a molding die.

In order to achieve these and other objects, according to one aspect of the invention, in a method for fabricating an optical glass element having at least one optical convex surface of a small radius of curvature by pressing a preform between a pair of molding dies, there is used a preform having a smallest radius of curvature which is smaller than a radius of a globular member having a volume equal to that of the preform.

In this fabricating method, an abutment portion between a molding die and the preform is located at a curved surface or the center of the molding die, thereby preventing any local abutment of the preform against the molding die. As a result, the lifetime of the molding die can be prolonged.

When the optical glass element is used in an optical pickup apparatus for a next-generation optical information recording medium, an optically effective portion ranges within a diameter of 1 mm at the center, so that a shape within a diameter of 1 mm at the center at a concave receiving die is configured with a shape error of 300 μm or less with respect to a shape corresponding to the counterpart molding die.

The invention is preferably applied to an optical glass element having a small radius of curvature and a great lens numerical aperture (NA), that is, a lens for use in an optical pickup apparatus for a next-generation optical information recording medium, wherein the numerical aperture of the lens is 0.65 or more.

The invention itself, together with further objects and attendant advantages, will best be understood by reference to the following detailed description taken in conjunction with the accompanying drawings.

### BRIEF DESCRIPTION OF THE DRAWINGS

FIG. 1 is a cross-sectional view showing an optical glass element having a small radius of curvature and a great lens numerical aperture (NA);

FIG. 2 is a view schematically showing an optical glass element molding method in the prior art;

FIG. 3 is a view schematically showing an optical glass element molding method in a first preferred embodiment according to the invention;

FIG. 4 is a view schematically showing an optical glass element molding method in a second preferred embodiment according to the invention;

FIG. 5 is a view schematically showing an optical glass element molding method in a third preferred embodiment according to the invention;

FIG. 6 is a view schematically showing a method for fabricating a molding preform for use in the optical glass element molding method;

FIG. 7 is a view showing a shrinkage state of the molding preform obtained in the fabricating method shown in FIG. 6;

FIG. 8 is an enlarged view showing essential parts of FIG. 7;

FIGS. 9A to 9D are views schematically showing the method for fabricating the molding preform for use in the molding method in the third preferred embodiment according to the invention, wherein FIG. 9A shows a manner in which molten glass is poured into a plurality of receiving dies, FIG. 9B is a perspective view showing a manner in which a glass block is formed by solidifying the molten glass, FIG. 9C shows a manner in which an extra flat portion of the glass block is ground, and FIG. 9D shows a molding preform obtained by grinding the glass block; and

FIGS. 10A and 10B are cross-sectional views schematically showing a pressing apparatus.

In the following description, like parts are designated by like reference numbers throughout the several drawing.

### DETAILED DESCRIPTION OF THE PREFERRED EMBODIMENTS

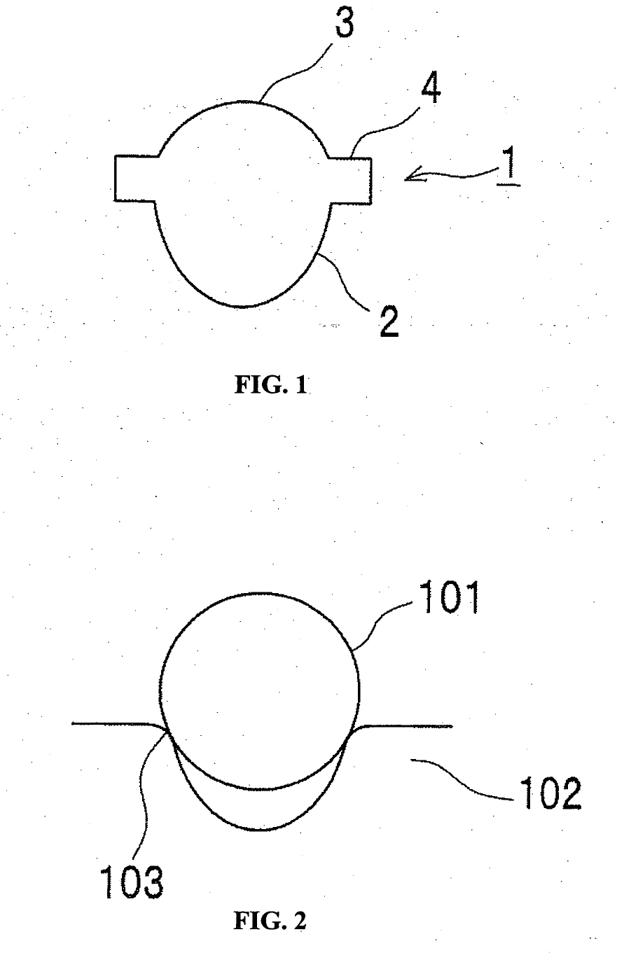

A detailed description will be given below of an optical glass element 1 molding method in a first preferred embodiment according to the invention in reference to FIGS. 1, 3, 6, 7 and 8.

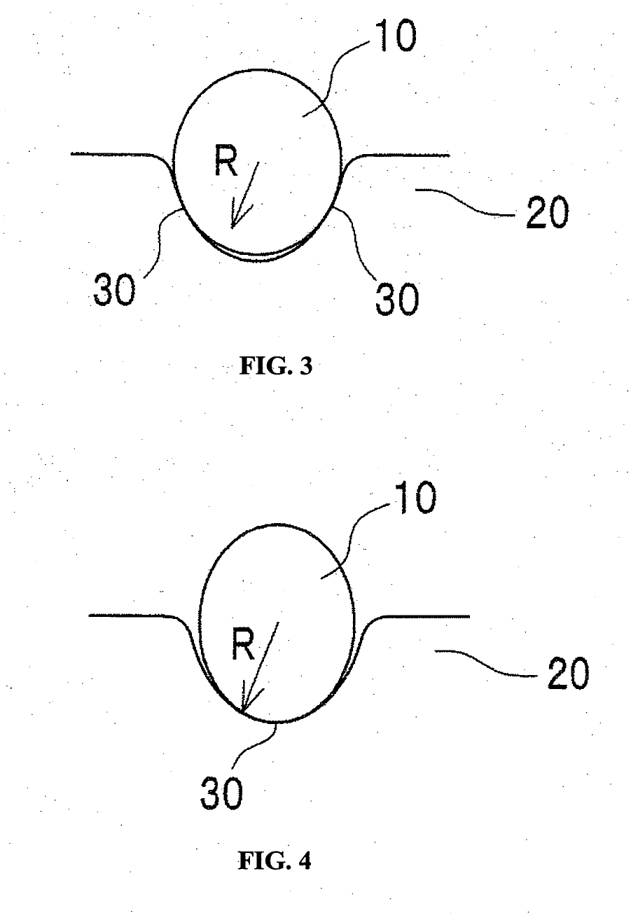

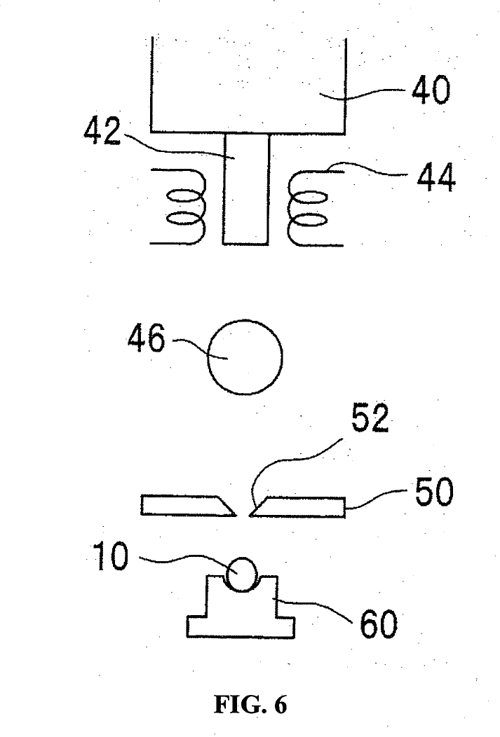

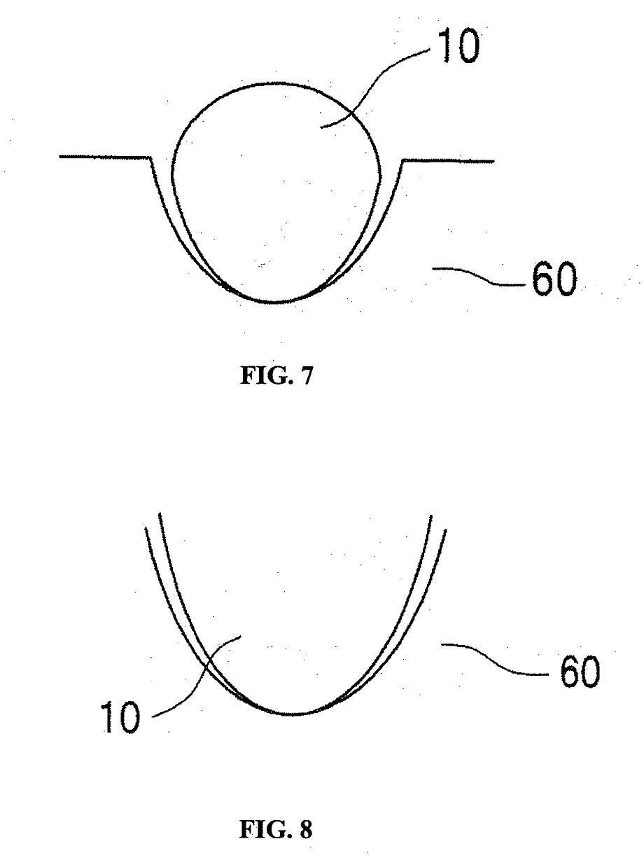

FIG. 1 is a cross-sectional view showing the optical glass element 1 according to the invention; FIG. 3 is a view schematically showing a molding method in the first preferred embodiment; FIG. 6 is a view schematically showing a method for fabricating a molding preform; FIG. 7 is a view showing a manner in which the molding preform is thermally shrunk in a molding preform fabricating process; and FIG. 8 is an enlarged view showing essential parts of FIG. 7.

As shown in FIG. 1, the optical glass element 1 according to the invention is relevant to a lens having a small radius of curvature and a great lens numerical aperture (NA), that is, an objective lens 1 for an optical head for use in an optical head used when information is recorded in or reproduced from an optical information recording medium such as a CD or a DVD, and further, is preferably applied to an objective lens for an optical head for use in a next-generation optical information recording medium in an “HD DVD” standard and a “Blu-Ray Disc” standard. The objective lens 1 is applied to an optical head in an optical information recording/reproducing apparatus, and therefore, has the function of converging a laser beam emitted from a semiconductor laser serving as a light source on the optical information recording medium such as a disk. The objective lens 1 serving as the optical glass element is a single biconvex lens including a first optical surface 2 having a small radius of curvature and a great projection, a second optical surface 3 having a great radius of curvature and a small projection, and edges 4 at both sides thereof.

The objective lens 1 shown in FIG. 1 is obtained by pressing a molding preform 10 fabricated by a method, described later, between a pair of molding dies.

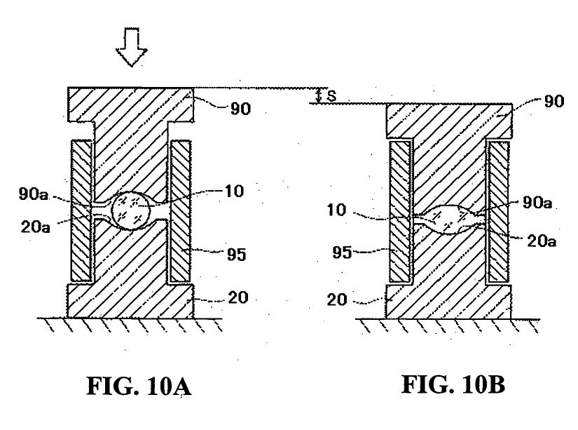

FIGS. 10A and 10B schematically show a pressing apparatus. A drum is disposed around the pair of molding dies, that is, a lower die 20 and an upper die 90. The upper die 90 can be vertically moved along a drum die 95. First, the preform 10 is supplied between a molding surface 20a of the lower die 20 and a molding surface 90a of the upper die 90. And then, the preform 10 is softened by increasing temperatures of the upper die 90, the lower die 20 and the drum die 95. Thereafter, the preform 10 is pressed by descending the upper die 90 by a stroke S.

The lower die has a concave molding surface in conformity with the desired first optical surface 2 having the small radius of curvature and the great projection: in contrast, the upper die has a concave molding surface in conformity with the desired second optical surface 3 having the great radius of curvature and the small projection. Each of the molding surfaces is very precisely machined within a surface precision of λ/4. The pair of upper and lower molding dies can be made of a thermally resistant material such as ceramic, carbide, carbon or metal. Among them, carbon or ceramic is preferable from the viewpoints of excellent heat conductivity and low reaction with glass.

The molding preform 10 is dimensionally configured in such a manner as to prevent, even if the preform 10 annularly linearly, that is, locally abuts against an edge of the lower die 20 in pressing, any concentrative application of a molding pressure to the abutment portion. Specifically, as shown in FIG. 3, the preform 10 is formed into a substantially oval shape at a projecting top having a smallest radius of curvature, and in other words, a great projection at a portion facing the molding surface of the lower die 20. The smallest radius of curvature of the preform 10 formed into a substantially oval shape is designed to become a radius of a globular member having a volume equal to that of the preform. An abutment portion 30 between the lower die 20 and the preform 10 is a curved side surface positioned at least at a bottom nearer than the edge since the preform 10 is formed into the substantially oval shape. The abutment portion 30 is positioned at a side circumferential surface, and further, the preform 10 is brought into planar contact with the lower die 20, thereby preventing any concentrative application of the molding pressure to a molding surface. As a consequence, the precisely molding surface cannot be damaged even in pressing numerous times, thus enhancing the durability of the lower die 20.

Incidentally, the preform 10 may be formed into an elliptic or oblong shape in cross section in addition to the substantially oval shape.

Explanation will be made on a method for fabricating the preform 10 formed into the substantially oval shape in reference to FIGS. 6, 7 and 8.

It is easy to fabricate the preform 10 when the diameter of the preform 10 is as relatively large as about 10 mm. In contrast, it is very difficult to fabricate the preform 10 when the diameter of the preform 10 is as fine as several millimeters or less, i.e., from about 0.5 mm to about 3 mm.

A drop method for fabricating the preform 10 with a molten glass droplet is advantageous from the viewpoint of cost reduction. In a simple drop method, the preform 10 having the above-described fine size is fabricated by setting an aperture diameter of a nozzle tip as small as possible. However, an aperture of a predetermined size is needed to allow molten glass to flow out through the aperture, or an apparent aperture diameter becomes large caused by a moisture of the molten glass at the nozzle tip. For these reasons, it is really impossible to remarkably reduce the aperture diameter of the nozzle tip. In view of this, a description will be given below of a method for fabricating the preform 10 by using a preform fabricating apparatus shown in FIG. 6.

The preform fabricating apparatus shown in FIG. 6 is basically constituted of a molten glass tank 40 for melting glass therein, a nozzle 42 attached to the bottom of the molten glass tank 40 so as to guide the molten glass to the outside, a droplet control member 50 which temporarily receives a molten glass droplet 46 naturally dropping from the tip of the nozzle 42 so as to produce a fine droplet, and a receiving die 60 for receiving the fine droplet thereon.

The droplet control member 50 is provided with a through pore 52 formed into a funnel having a slope. The through pore 52 has an aperture smaller in size than the molten glass droplet 46. Moreover, the through pore 52 is tapered in a drop direction. The through pore 52 may have a cylindrical surface in place of the slope. The droplet control member 50 can be made of a thermally resistant material such as ceramic, carbide, carbon or metal. Among them, carbon or ceramic is preferable from the viewpoints of excellent heat conductivity and low reaction with glass.

The receiving die 60 has a concave molding surface suitable for obtaining the preform 10 formed into the desired substantially oval shape. The receiving die 60 also can be made of a thermally resistant material such as ceramic, carbide, carbon or metal. Among them, carbon or ceramic is preferable from the viewpoints of excellent heat conductivity and low reaction with glass. The receiving die 60 within a diameter of 1 mm at the center of the concave molding surface is finished with a shape error of 300 μm or less with respect to the shape of a portion in conformity with the counterpart molding die.

In FIG. 6, when the molten glass droplet 46 naturally drops from the tip of the nozzle 42, the molten glass droplet 46 collides on the upper surface of the droplet control member 50, wherein the molten glass droplet 46 is received in a region around the through pore 52 on the upper surface of the droplet control member 50. And then, a part of the molten glass droplet 46 passes through the through pore 52 with the collision on the droplet control member 50. When the molten glass droplet 46 passes through the through pore 52 as a narrow passage, the balance of the dropping force of the molten glass droplet 46 with the surface tension of the molten glass droplet 46 allows a fine quantity of molten glass droplet 46 to pass through, although the molten glass droplet 46 in excess of a predetermined quantity cannot pass through. Thereafter, since the surface tension of the molten glass droplet 46 is larger than the dropping force of the molten glass droplet 46, the molten glass droplet 46 remaining at the upper surface of the droplet control member 50 intends to return to its original state, to be thus abruptly moved upward. As a consequence, the molten glass droplet 46 is divided into a droplet remaining at the upper surface of the droplet control member 50 and a dropping droplet of a fine size.

The dropping droplet of a fine size is received at the concave molding surface of the receiving die 60. The droplet remains highly fluidic in a low viscosity, and therefore, the fine droplet substantially conforms with the shape of the concave molding surface of the receiving die 60. The fine droplet is thermally shrunk in a cooling process, that is, a so-called molding sink phenomenon occurs, and therefore, the radius of curvature of the fine droplet becomes smaller than that of the concave molding surface, as shown in FIGS. 7 and 8. In other words, the tip becomes sharper. In this manner, it is possible to obtain the fine preform 10 having one surface curved in conformity with the concave molding surface and the other free surface. Here, the concave molding surface of the receiving die 60 can be formed into a shape having the radius of curvature slightly greater than that of the desired preform 10 in consideration of the above-described thermal shrinkage of the glass droplet.

Subsequently, a description will be given below of a method for molding an optical glass element 1 in a second preferred embodiment according to the invention in reference to FIG. 4.

A method for molding an objective lens 1 serving as an optical glass element is basically the same as in the above-described first preferred embodiment except for the shape of a preform 10 for use in pressing. Specifically, as shown in FIG. 4, the radius of curvature of the preform 10 is smaller than that of a bottom of a molding surface of a lower die 20. In other words, the preform 10 is formed into a substantially oval shape with a tip sharper than that of the preform 10 in the above-described first preferred embodiment (see FIG. 3). The substantially oval preform 10 having the sharp tip positions an abutment portion 30 between the lower die 20 and the preform 10 at or near a bottom. The abutment portion 30 is positioned at or near the bottom, and further, the preform 10 is brought into planar contact with the lower die 20, thereby preventing any concentrative application of a molding pressure. As a consequence, the precisely molding surface cannot be damaged even in pressing numerous times, thus enhancing the durability of the lower die 20.

Next, a description will be given below of a method for molding an optical glass element 1 in a third preferred embodiment according to the invention in reference to FIGS. 1, 5 and 9, although a description common to that in the above-described first preferred embodiment will be omitted below.

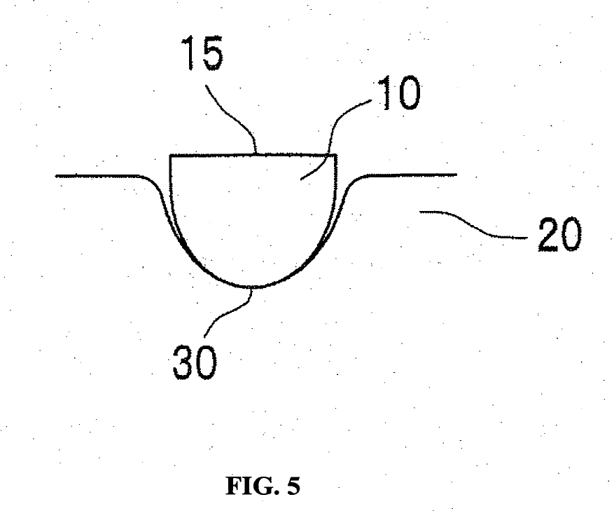

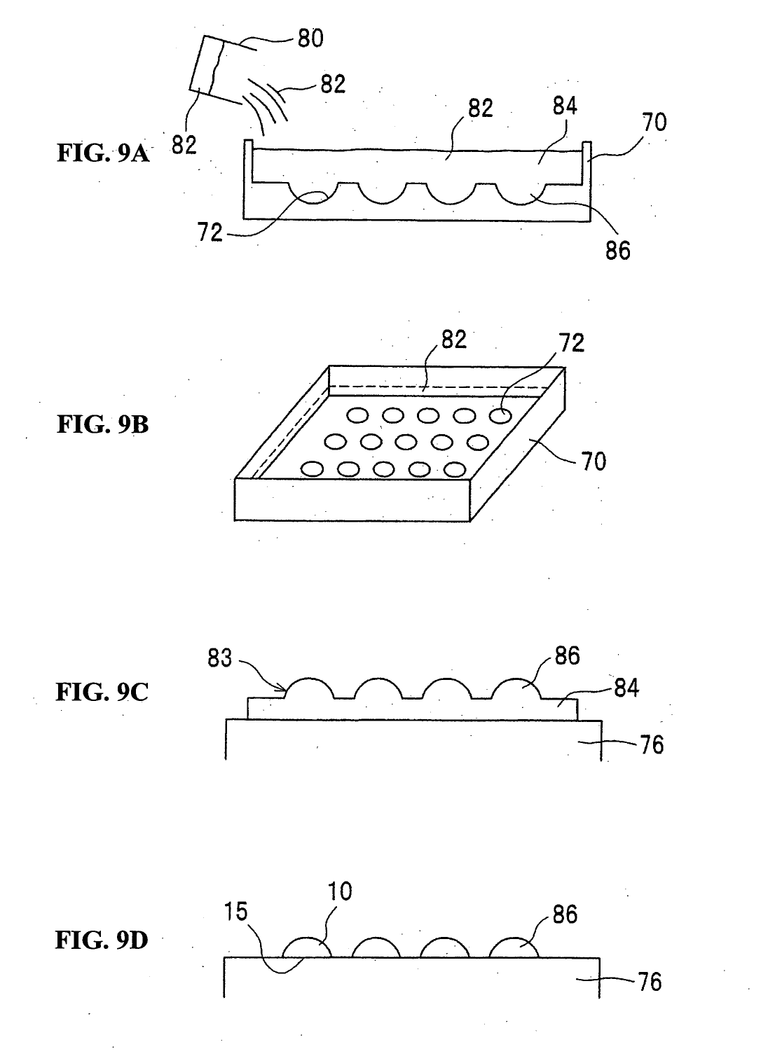

FIG. 1 is a cross-sectional view showing the optical glass element 1 according to the invention; FIG. 5 is a view schematically showing a molding method in the third preferred embodiment; and FIGS. 9A to 9D are views schematically showing the method for fabricating a preform 10.

As shown in FIG. 1, an objective lens 1 serving as an optical glass element includes a first optical surface 2 having a small radius of curvature and a great projection and a second optical surface 3 having a great radius of curvature and a small projection. According to a lens design, the second optical surface 3 of the objective lens 1 may be formed into an almost plane having a very great radius of curvature and a slight projection.

Consequently, when the desired objective lens 1 includes the first optical surface 2 having the small radius of curvature and the great projection and the second optical surface 3 formed into an almost plane having the very great radius of curvature and the slight projection, the preform 10 formed into a shape shown in FIG. 5 can be used. Specifically, the preform 10 shown in FIG. 5 is formed into a semi-oval shape obtained by half cutting a substantially oval member in a short-axial direction, and therefore, has the first optical surface 2 having the small radius of curvature and the great projection and the second optical surface 3 as a flat surface 15. An abutment portion 30 between a lower die 20 and the preform 10 is a curved side surface positioned at least at a bottom nearer than an edge since the preform 10 is formed into the semi-oval shape. The abutment portion 30 is positioned at a side circumferential surface, and further, the preform 10 is brought into planar contact with the lower die 20, thereby preventing any concentrative application of the molding pressure to the first optical surface 2. As a consequence, the precisely molding surface cannot be damaged even in pressing numerous times, thus enhancing the durability of the lower die 20.

Explanation will be made on a method for fabricating the preform 10 formed into the semi-oval shape in reference to FIGS. 9A to 9D.

The preform 10 shown in FIGS. 9A to 9D is fabricated by using a molten glass vessel 80 having molten glass 82 reserved therein, a plurality of receiving dies 70, into which the molten glass 82 reserved in the molten glass vessel 80 is poured, and a machining table 76, on which the preform 10 is obtained by machining, e.g., grinding a glass block 83.

As shown in FIG. 9A, each of the plurality of box-shaped receiving dies 70 is provided at the bottom thereof with a plurality of concaves 72 serving as concave molding surfaces of the receiving die 60. Each of the plurality of receiving dies 70 can be made of a thermally resistant material such as ceramic, carbide, carbon or metal. Among them, carbon or ceramic is preferable from the viewpoints of excellent heat conductivity and low reaction with glass. The molten glass 82 reserved in the molten glass vessel 80 is poured into each of the plurality of receiving dies 70. The molten glass 82 is poured in a height in slight excess of the level of the concaves 72. As shown in FIG. 9B, the molten glass 82 is left stationarily and cooled down to room temperature until it is solidified, thereby forming the glass block 83. The glass block 83 includes an extra flat portion 84 which is the molten glass excessively poured, and convexes 86 in conformity with the concaves 72. As shown in FIG. 9C, the glass block 83 is held by a holding jig, not shown, and then, is arranged in such a manner that the extra flat portion 84 faces the machining table 76 such as a grinding table or a polishing table. Finally, as shown in FIG. 9D, when the extra flat portion 84 is removed from the glass block 83 together with the machining table 76, each of the convexes 86 is separated from the glass block 83, thus obtaining the plurality of convexes 86 serving as the preform 10 having the flat surface 15 and a convex surface, as shown in FIG. 5. In this manner, many preforms 10 can be obtained at one time, thus reducing the fabrication cost of the preform 10.

### EXAMPLE 1

Glass of Type SF57 was molten. About 200 mg of the molten glass droplet 46 was made to drop through the nozzle having an outer diameter of 4 mm down to the droplet control member 50 provided with the through pore 52 having an aperture diameter of 2 mm. The fine droplet having a weight of 35 mg, passing through the through pore 52, dropped. The dropping fine droplet was received at the concave molding surface, having a radius of curvature of 0.8 mm, of the receiving die 60. As a result, it was possible to obtain the fine preform 10 including one convex surface having a radius of curvature of 0.8 mm and the other free surface.

Thereafter, the fine preform 10 was hotly pressed between the lower die 20, which was highly precisely machined in a radius of curvature of 1.2 mm, and the upper die 90, which was highly precisely machined in a radius of curvature of 90 mm. The upper and lower molding dies were heated up to 400° C., followed by pressing with the application of a pressure of 0.5 kgw/cm2. The objective lens 1 for “the HD DVD” obtained by pressing resulted in a profile irregularity of λ/6 or more and a lens numerical aperture (NA) of 0.65. As a result of the observation of the lower die 20 by a microscope after the resultant optical glass element 1 was pressed 2000 times, it was revealed that the lower die 20 was free from neither generation of a flaw nor deformation at the molding surface, with an attendant advantage of a very excellent durability.

### EXAMPLE 2

Glass of Type SF57 was molten. About 200 mg of the molten glass droplet 46 was made to drop through the nozzle having an outer diameter of 4 mm down to the droplet control member 50 provided with the through pore 52 having an aperture diameter of 2 mm. The fine droplet having a weight of 35 mg, passing through the through pore 52, dropped. The dropping fine droplet was received at the concave molding surface, having a radius of curvature of 1.3 mm, of the receiving die 60. As a result, it was possible to obtain the fine preform 10 including one convex surface having a radius of curvature of 1.3 mm and the other free surface.

Thereafter, the fine preform 10 was hotly pressed between the lower die 20, which was highly precisely machined in a radius of curvature of 1.2 mm, and the upper die 90, which was highly precisely machined in a radius of curvature of 90 mm. The upper and lower molding dies were heated up to 400° C., followed by pressing with the application of a pressure of 0.5 kgw/cm2. The objective lens 1 for “the HD DVD” obtained by pressing resulted in a profile irregularity of λ/6 or more and a lens numerical aperture (NA) of 0.65. As a result of the observation of the lower die 20 by a microscope after the resultant optical glass element 1 was pressed 2000 times, it was revealed that the lower die 20 was free from neither generation of a flaw nor deformation at the molding surface, with an attendant advantage of a very excellent durability.

### EXAMPLE 3

Glass of Type LaK8 molten at a temperature of 1050° C. was poured into each of the plurality of box-shaped receiving dies 70, each of which was provided with 50 concaves 72 having a radius of curvature of 0.8 mm, thereby producing the glass block 83. The extra flat portion 84 of the glass block 83 was removed by polishing, thereby 50 preforms 10 were obtained.

Thereafter, the fine preform 10 was hotly pressed between the lower die 30, which was highly precisely machined in a radius of curvature of 1.2 mm, and the upper die 30, which was highly precisely machined in a radius of curvature of 90 mm. The upper and lower molding dies were heated up to 680° C., followed by pressing with the application of a pressure of 0.5 kgw/cm2. The objective lens 1 for “the Blu-Ray Disc” obtained by pressing resulted in a profile irregularity of λ/6 or more and a lens numerical aperture (NA) of 0.85. As a result of the observation of the lower die 20 by a microscope after the resultant optical glass element 1 was pressed 2000 times, it was revealed that the lower die 20 was free from neither generation of a flaw nor deformation at the molding surface, with an attendant advantage of a very excellent durability.

Although the present invention has been fully described by way of examples with reference to the accompanying drawings, it is to be noted that various changes and modifications will be apparent to those skilled in the art. Therefore, unless such changes and modification depart from the scope of the present invention, they should be constructed as being included therein.

What is claimed is:

1. A method for fabricating an optical glass element having at least one optical convex surface of a small radius of curvature by pressing a preform between a pair of molding dies, said method using the preform having a smallest radius of curvature which is smaller than a radius of a globular member having a volume equal to that of the preform.

2. A fabricating method according to claim 1, wherein said preform is formed in a process where a molten glass droplet is received by a receiving die having a smallest radius of curvature which is smaller than that of a globular member having a volume equal to that of the preform.

3. A fabricating method according to claim 1, further comprising the steps of:
pouring a molten glass into a plurality of receiving dies which having a smallest radius of curvature which is smaller than that of a globular member having a volume equal to that of the preform;
cooling and solidifying the molten glass to form a glass block having a plurality of convex portions; and
grinding a flat surface opposite to the surface having the plurality of convex surface.

4. A fabricating method according to claim 2, wherein an optically effective portion ranges within a diameter of 1 mm at the center, so that a shape within a diameter of 1 mm at the center at a concave portion of the receiving die is configured with a shape error of 300 μm or less with respect to a shape corresponding to the counterpart molding die.

5. A fabricating method according to claim 1, wherein a numerical aperture of the optical glass element is 0.65 or more.

6. A fabricating method according to claim 5, wherein the optical glass element is used alone as a glass objective lens for optical pickup apparatus.

7. A fabricating method according to claim 1, wherein the preform is pressed in a situation where the preform abuts a circumferential potion of the molding surface of the die.

8. A fabricating method according to claim 1, wherein the preform is pressed in a situation where the preform abuts a bottom of the molding surface of the die of a neighborhood of the bottom.

9. A method for fabricating an glass objective lens a numerical aperture of which is 0.65 or more for optical pickup apparatus, said method comprising the step of press-molding a preform by a pair of dies, wherein
said method using the preform having a smallest radius of curvature which is smaller than a radius of a globular member having a volume equal to that of the preform.

10. A fabricating method according to claim 9, wherein said preform is formed by a process where a molten glass droplet is received by a receiving die having a smallest radius of curvature which is smaller than that of a globular member having a volume equal to that of the preform.

11. A fabricating method according to claim 9, further comprising the steps of:
pouring a molten glass into a plurality of receiving dies which having a smallest radius of curvature which is smaller than that of a globular member having a volume equal to that of the preform;
cooling and solidifying the molten glass to form a glass block having a plurality of convex portions; and
grinding a flat surface opposite to the surface having the plurality of convex surface.

12. A fabricating method according to claim 10, wherein an optically effective portion ranges within a diameter of 1 mm at the center, so that a shape within a diameter of 1 mm at the center at a concave portion of the receiving die is configured with a shape error of 300 μm or less with respect to a shape corresponding to the counterpart molding die.

13. A fabricating method according to claim 9, wherein the preform is pressed in a situation where the preform abuts a circumferential potion of the molding surface of the die.

14. A fabricating method according to claim 9, wherein the preform is pressed in a situation where the preform abuts a bottom of the molding surface of the die of a neighborhood of the bottom.
